(19) United States
(12) Patent Application Publication
(10) Pub. No.: US 2024/0099268 A1
(43) Pub. Date: Mar. 28, 2024

(54) Pet Toy

(71) Applicant: Rita Olsen, Oak Lawn, IL (US)

(72) Inventor: Rita Olsen, Oak Lawn, IL (US)

(21) Appl. No.: 18/519,918

(22) Filed: Nov. 27, 2023

Related U.S. Application Data
(60) Provisional application No. 63/410,390, filed on Sep. 27, 2022.

(51) Int. Cl. A01K 15/02

(52) U.S. Cl. CPC A01K 15/025; H04R 1/028

(57) ABSTRACT

A pet toy which may be used by an owner to interact (i.e., play) with their pet(s). The toy comprises of a remote-control signal transmitter, a signal receiver, and a plurality of speakers. When a user activates the remote-control signal transmitter, the signal receiver generates sounds through one or more speakers. This allows the owner to hide the signal receiver under a blanket, behind a couch, or some other location and then activate sound using the remote-control signal transmitter and watch their pet look for the signal receiver.

### CROSS-REFERENCE TO RELATED APPLICATIONS

This application relates back to provisional application U.S. 63/410,390 filed on Sep. 27, 2022 and is claimed in its entirety.

### BACKGROUND OF THE INVENTION

Pets love to play and exercise is a required part of a pet's life. The present subject matter is meant to be a toy which helps facilitate exercise and be fun for a pet at the same time. Both cats and dogs are natural hunters and the pet toy disclosed herein helps stimulate those instincts.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The present subject matter is directed towards a pet toy. The presently disclosed toy may be used by an owner to interact (i.e. play) with their pet(s). The presently disclosed toy may comprise a remote-control signal transmitter 10 shown in FIG. 1 and a signal receiver 20 shown in FIG. 2. When a user activates the remote-control signal transmitter 10, the signal receiver 20 generates sounds through one or more speakers 25. This may allow the owner to hide the signal receiver 20, for example, under a blanket or behind a couch, then activate sound using the remote-control signal transmitter 10 and watch their pet look for the signal receiver 20.

According to some embodiment, the signal receiver 20 may be hidden inside pet's favorite toy or stuffed toy 30 shown in FIG. 3. According to some embodiment, the signal receiver generates a sound that is a squeaking sound or any other noise which is intended to obtain a pet's interest. According to some embodiment, the owner may be located remotely and use the remote-control signal transmitter to keep their pet occupied while owner is away.

In some embodiments, the signal receiver, plurality of speakers and remote-controlled signal transmitter are battery operated. In other embodiments, the signal may come from a smartphone via Bluetooth to activate the signal receiver and emit the sound within the toy.

According to some embodiment, the remote-control signal transmitter 10 may comprise a radio frequency (RF) circuitry. The RF circuitry may be configured to transmit RF signals, also called electromagnetic signals. The RF circuitry converts electrical signals to electromagnetic signals and communicates with communications networks and other communications devices via the electromagnetic signals. The RF circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document. According to some embodiment, the remote-control signal transmitter may comprise a button owner can use to activate the radio frequency (RF) circuitry and transmit to the signal receiver.

According to some embodiment, the signal receiver 20 may comprise a radio frequency (RF) circuitry. The RF circuitry of the signal receiver may be configured to receive RF signals, also called electromagnetic signals, from the remote-control signal transmitter. The RF circuitry of the signal receiver may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry of the signal receiver may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

### BRIEF DESCRIPTION OF DRAWINGS

FIG. 1 shows a top view of the remote-controlled signal transmitter.

FIG. 2 shows a top view of the signal receiver.

FIG. 3 shows a perspective view of the pet toy.

### DETAILED DESCRIPTION OF THE INVENTION

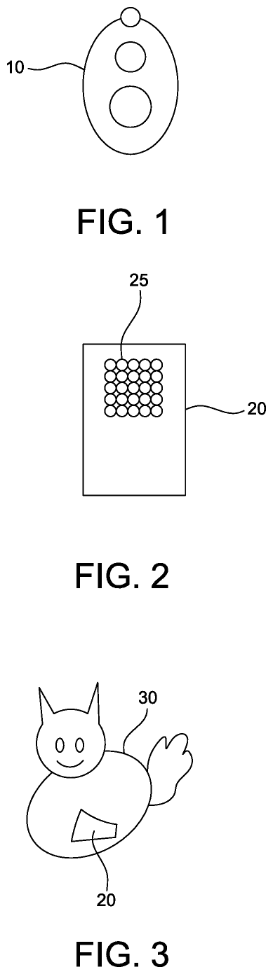

FIG. 1 shows a top view of the remote-controlled signal transmitter 10 wherein the signal is sent to the signal receiver which emits a sound which attracts a pet's attention to encourage play.

FIG. 2 shows a top view of the signal receiver 20 which would be placed inside of the pet's favorite toy. Once the signal is received from the transmitter 10, the signal receiver 20, emits a sound to attract the pet's attention from a plurality of speakers 25.

FIG. 3 shows a perspective view of the pet toy with the signal receiver 20 embedded within the toy. The present subject matter may be prefabricated in a toy or may be transplanted into the pet's favorite toy. The toy is then hidden in a random location within the pet's home or territory and the user uses the remote to emit a sound. The pet is then alerted to the toy's presence and begins to hunt for it. Once the pet locates the toy, the user may reward the pet and hide the toy again.

1. A pet toy comprising of a remote-controlled signal transmitter, signal receiver, and plurality of speakers.

2. The pet toy as in claim 1, wherein the signal receiver and speakers are located inside of a pet toy, stuffed animal, or other object a pet likes to play with.

3. The pet toy as in claim 1, wherein the signal transmitter sends a signal to the signal receiver wherein the plurality of speakers emits a sound designed to attract the attention of a pet.

4. The pet toy as in claim 1, wherein the signal transmitter may come from a phone using Bluetooth.

5. The pet toy as in claim 1, wherein the signal receiver and plurality of speakers may be premanufactured into a toy or transplanted into a pet's favorite toy.

6. A method of manufacturing a pet toy comprising of a remote-controlled signal transmitter, signal receiver, and plurality of speakers.

7. The method of manufacturing the pet toy as in claim 6, wherein the signal receiver and speakers are located inside of a pet toy, stuffed animal, or other object a pet likes to play with.

8. The method of manufacturing the pet toy as in claim 6, wherein the plurality of speakers emits a sound designed to attract the attention of a pet.

9. The method of manufacturing the pet toy as in claim 6, wherein the signal transmitter may come from a phone using Bluetooth.

10. The method of manufacturing the pet toy as in claim 6, wherein the signal receiver and plurality of speakers may be premanufactured into a toy or transplanted into a pet's favorite toy.
